(19) United States
(12) Patent Application Publication
(10) Pub. No.: US 2010/0060912 A1
(43) Pub. Date: Mar. 11, 2010

(54) PRINTING SYSTEM AND SECURE DOCUMENT PRINTING METHOD

(75) Inventor: Hee-yoon KANG, Cheongwon-gun (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/389,520

(22) Filed: Feb. 20, 2009

(30) Foreign Application Priority Data
Sep. 9, 2008 (KR) 2008-88831

(51) Int. Cl. H04N 1/60; G06K 15/00

(52) U.S. Cl. 358/1.9; 358/1.14

(57) ABSTRACT

A printing system can include an output unit to print printing data using main developers including a cyan (C) developer, a yellow (Y) developer, a magenta (M) developer, a black (K) developer, and a supplementary developer, a detection unit to detect whether a security mark is present in the printing data, and a control unit to control the output unit to print the security mark using the supplementary developer if the detection unit detects the security mark in the printing data.

### CROSS-REFERENCE TO RELATED APPLICATIONS

This application claims priority under 35 U.S.C. §119 (a) from Korean Patent Application No. 10-2008-0088831, filed on Sep. 9, 2008, in the Korean Intellectual Property Office, the disclosure of which is incorporated herein by reference in its entirety.

### BACKGROUND

1. Field of the Invention

The present general inventive concept relates to a printing system. More particularly, the present general inventive concept relates to a printing system to print secure documents using a supplementary developer, and a secure document printing method.

2. Description of the Related Art

In our modern information-oriented society, information security is a matter of crucial importance. In particular, companies dealing with confidential information such as trade secrets and new technologies keenly feel the necessity to prevent leaks of confidential information. Such confidential information may be printed by image forming apparatuses. Documents including confidential information are referred to hereinbelow as secure documents. When an image forming apparatus prints a secure document, it is necessary to deal with the security of the secure document differently from that of other documents.

Accordingly, a printing system enables the image forming apparatus to print terms indicating security such as “secret,” “secure document,” “confidential,” or “no copy” or symbols on the entire pages of the secure document. Such terms or symbols indicating security are referred to hereinbelow as security marks. Occasionally, security marks need not be visible, for example, when contract documents are printed. In typical printing systems, since security marks are collectively printed to be visible on secure documents, a user may feel an inconvenience.

### SUMMARY

Example embodiments of the present general inventive concept provide a printing system to print a secure document using a supplementary developer, and a secure document printing method.

Additional embodiments of the present general inventive concept will be set forth in part in the description which follows and, in part, will be obvious from the description, or may be learned by practice of the general inventive concept.

Example embodiments of the present general inventive concept may be achieved by providing a printing system including an output unit to print printing data using main developers including a cyan (C) developer, a yellow (Y) developer, a magenta (M) developer, a black (K) developer, and a supplementary developer, a detection unit to detect whether a security mark is present in the printing data, and a control unit to control the output unit to print the security mark using the supplementary developer if the detection unit detects the security mark in the printing data.

A color depth of the supplementary developer may be lower than a color depth of the main developers.

The supplementary developer may be one of a light C developer, a light Y developer, a light M developer, a light K developer, a white developer, and a transparent developer.

Example embodiments of the present general inventive concept may also be achieved by providing a printing system including an input unit to input printing data, an output unit to print the printing data using main developers including a cyan (C) developer, a yellow (Y) developer, a magenta (M) developer, a black (K) developer, and a supplementary developer, a detection unit to detect whether a security mark is present in the printing data, a printing mode determination unit to determine a printing mode according to the detection result of the detection unit, a developer mode determination unit to determine a developer mode indicating whether to print the detected security mark using the main developers or the supplementary developer, and a control unit to control the output unit to print the printing data along with the security mark according to the printing mode and the developer mode.

The printing mode may include a general printing mode to be set to print the printing data without restriction if the detection unit does not detect the security mark from the printing data, and a secure printing mode to be set to print the printing data with restrictions if the detection unit detects the security mark from the printing data.

The secure printing mode may include a first mode to disallow printing, a second mode to display a warning, and a third mode to allow printing of fewer than or equal to a predetermined number of sheets of paper.

The secure printing mode may be initialized as one of the first to third modes, or be set by a user.

The developer mode may be initialized as one of the main developers and the supplementary developer, or be set by a user.

The printing system may further include a storage unit to store a preset security mark. The detection unit may detect whether the printing data include the security mark stored in the storage unit.

The user may add the security mark to the storage unit or delete the security mark from the storage unit.

The detection unit may include a first detector to detect whether the supplementary developer is present on the printing data by measuring a reflected wavelength, and a second detector to detect whether the security mark is present in the printing data if the first detector does not detect the supplementary developer.

The first detector may include a sensor to measure the reflected wavelength.

The supplementary developer may include a magnetic or metal substance.

The detection unit may include a first detector to detect whether the supplementary developer is present on the printing data by measuring a change in a magnetic field, and a second detector to detect whether the security mark is present in the printing data if the first detector does not detect the supplementary developer.

The first detector may include a sensor to measure the change in the magnetic field.

The printing system may further include a stopping unit to stop the operation of the detection unit.

The security mark may be formed on a predetermined area of the printing data, and the detection unit may detect whether the security mark is present on the predetermined area of the printing data.

The printing system may further include a display setting unit to display and set the printing mode and the developer mode.

Example embodiments of the present general inventive concept may also be achieved by providing a secure document printing method including inputting printing data, detecting whether a security mark is present in the printing data, determining a printing mode according to the result of detection of the security mark, determining a developer mode indicating whether to print the detected security mark using main developers or a supplementary developer, and processing the printing data according to the printing mode and the developer mode.

Example embodiments of the present general inventive concept may also be achieved by providing a method of printing data, the method including detecting whether the data to be printed comprises a security mark, determining whether the security mark is to be visibly printed on a document, and printing the security mark on the document using main developers or a supplementary developer according to the result of the determining.

The detecting whether the data comprises a security mark can include scanning the data to detect whether supplemental developer is present on the scanned data.

The method may further include measuring a characteristic of the detected supplemental developer.

The characteristic can be one of a reflected wavelength and a magnetic field of the detected supplemental developer.

The method may further include adding a substance to the supplemental developer to change a reflected wavelength of the supplemental developer.

Example embodiments of the present general inventive concept may also be achieved by providing an image forming apparatus, including an input unit to input image data, a detection unit to detect whether a security mark is present in the image data, and an output unit to print the security mark using a supplementary developer when the detection unit detects the security mark in the image data.

The detection unit may include a first detector to detect whether the security mark is present when the image data is input by a scanner, and a second detector to detect whether the security mark is present when the image data is input by a server or personal computer (PC).

The first detector can detect whether the security mark is present by detecting whether supplemental developer is present in the scanned image data, and the second detector can detect whether the security mark is present by using an image matching scheme.

The security mark may be located in a predetermined area of the image data.

### BRIEF DESCRIPTION OF THE DRAWINGS

These and/or other embodiments of the present general inventive concept will become apparent and more readily appreciated from the following description of the embodiments, taken in conjunction with the accompanying drawings of which:

FIG. 1 is a block diagram illustrating a printing system according to an exemplary embodiment of the present general inventive concept;

FIG. 2 illustrates a secure document printed by the printing system of FIG. 1;

FIG. 3 is a schematic perspective view of a display setting unit; and

FIG. 4 is a flowchart illustrating a secure document printing method according to an exemplary embodiment of the present general inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

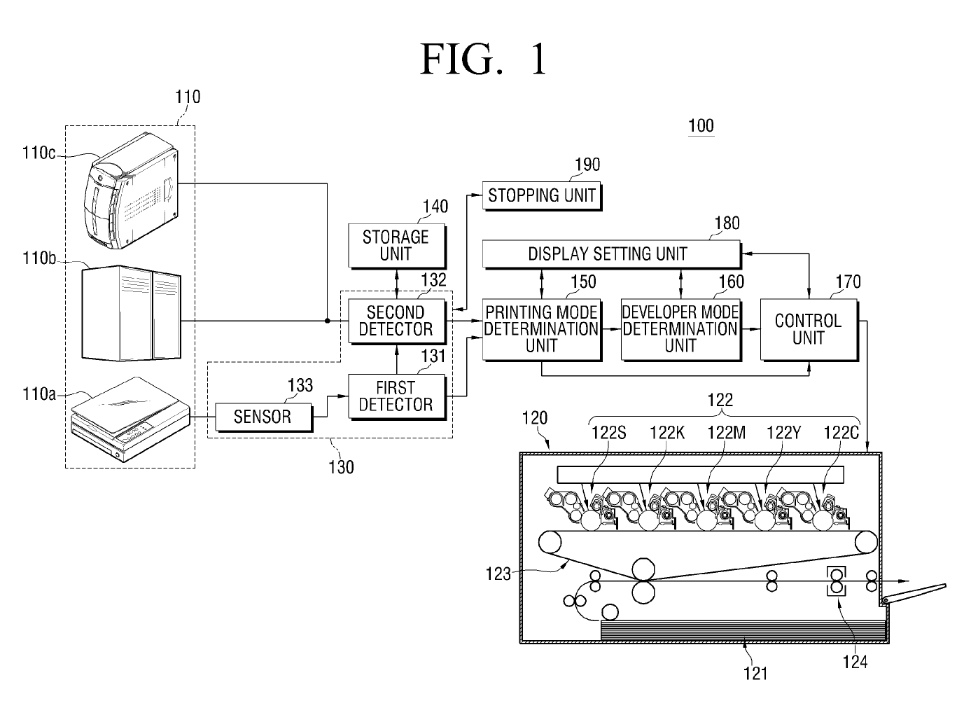

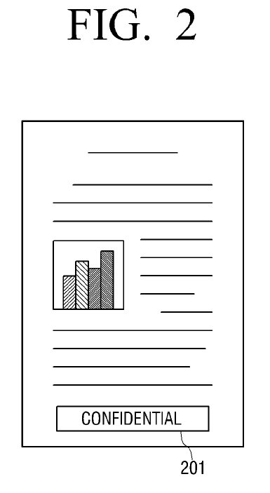

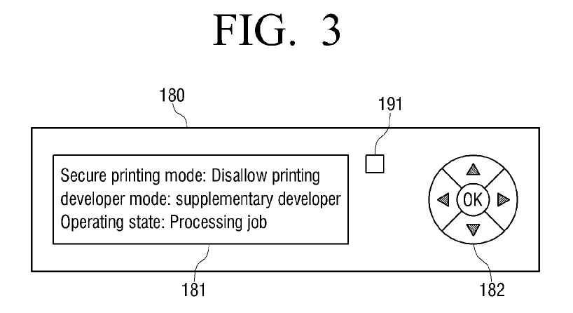

FIG. 1 is a block diagram illustrating a printing system according to an exemplary embodiment of the present general inventive concept, FIG. 2 illustrates a secure document printed by the printing system of FIG. 1, and FIG. 3 is a schematic perspective view of a display setting unit.

The printing system 100 may include an input unit 110, an output unit 120, a detection unit 130, a storage unit 140, a printing mode determination unit 150, a developer mode determination unit 160, a control unit 170, a display setting unit 180, and a stopping unit 190.

The input unit 110 inputs printing data, and the printing data can be printed by the output unit 120. Printing data to be printed as a secure document include a security mark, and printing data to be printed as a general document do not include a security mark. As illustrated in FIG. 1, the input unit 110 may be a scanner 110a, a server 110b, or a personal computer (PC) 110c. However, the input unit 110 is not limited to such devices, and may be any known or later developed device capable of inputting printing data. In addition, the input unit 110 may be a copier or a multifunction peripheral, in which the scanner 110a and the output unit 120 are combined.

The output unit 120 can print the printing data input by the input unit 110 using main developers, including cyan (C), yellow (Y), magenta (M), and black (K), and a supplementary developer. The output unit 120 may be an image forming apparatus using an electrophotographic method. The output unit 120 may include a feeding unit 121, a developing unit 122, a transfer unit 123, and a fusing unit 124. The configuration and functions of the output unit 120 are well known to those skilled in the related art, so a detailed description is omitted here.

According to an exemplary embodiment of the present general inventive concept, the developing unit 122 may include developing parts 122C, 122Y, 122M, and 122K using the CYMK developers, respectively, and a developing part 122S using the supplementary developer. The security mark may be printed using the supplementary developer or the main developers.

The color depth of the supplementary developer may be lower than that of the CYMK developers. For example, the supplementary developer may be a light C developer, light Y developer, light M developer, light K developer, white developer, or transparent developer. If a security mark is printed using such a supplementary developer, the security mark is not easily visible to the unaided eye, unlike images printed using the main developers. Accordingly, the supplementary developer can be useful to print contract documents in which security marks must not be visible. If security marks are printed using a transparent developer, it is almost impossible for the security mark to be distinguished by the unaided eye.

The detection unit 130 can detect whether data input by the input unit 110 include a security mark. The detection unit 130 may include a first detector 131, a second detector 132, and a sensor 133.

The first detector 131 can detect whether printing data has a predetermined security mark if the printing data are input by being scanned by the scanner 110a. In this case, the security mark may be formed in only a predetermined area of the printing data. For example, as illustrated in FIG. 2, a security mark 201 may be formed on only the bottom central portion of printing data. The predetermined area may be any part of the printing data, and the position of the predetermined area may be fixed. The position of the predetermined area may be set by a user or preset as an initial value. The first detector 131 can then detect whether a security mark is present in the predetermined area of the printing data.

The first detector 131 can detect whether the supplementary developer is present on the scanned paper. Presence of the supplementary developer on the scanned paper indicates that there is a security mark on the scanned paper. As described above, if printing data are input by scanning paper, whether a security mark is present in the printing data can be determined indirectly by detecting whether the supplementary developer is present on the scanned paper.

The supplementary developer can be distinguished using color differences between the supplementary developer and the main developers. Specific colors can be distinguished using generally known methods, so a detailed description is omitted here. Since the color of the supplementary developer is different from the colors of the main developers, the wavelength of the light reflected from the supplementary developer is different from the wavelengths of the light reflected from the main developers. When paper is scanned, the sensor 133 can measure the wavelengths reflected from the developers, and the first detector 131 can detect whether there is a wavelength reflected from the supplementary developer based on the result of measurement of the sensor 133 to detect whether the supplementary developer is present on the scanned paper.

However, if the supplementary developer is a white developer or a transparent developer, it is difficult to detect the supplementary developer since paper is generally white. In this case, in order to differentiate the wavelength reflected from the supplementary developer from the wavelengths reflected from other developers or the paper, a substance to change the reflected wavelength may be added into the supplementary developer. For example, an infrared light absorbent responsive only to infrared light, an ultraviolet light absorbent responsive only to ultraviolet light, or a fluorescent material may be added. However, methods of distinguishing the supplementary developer from the main developers are not limited thereto, and other diverse methods may be used. If the scanner 110a is not used as the input unit 110, it may not be necessary to add a substance changing a reflected wavelength to a white developer or a transparent developer.

A method of adding a magnetic or metal substance into the supplementary developer may be used instead of a method of detecting the supplementary developer using the reflected wavelength. In this case, the sensor 133 can measure a change in the magnetic field to detect whether the supplementary developer is present on the scanned paper.

In accordance with example embodiments of the present general inventive concept, whether a document to be scanned is a secure document can be readily determined by measuring a reflected wavelength or a change in the magnetic field, but the determination method is not limited thereto. For example, whether a document to be scanned is a secure document can also be determined by measuring other material properties or characteristics of the supplementary developer which can be distinguished from those of the main developers.

If a security mark is printed using the main developers, the first detector 131 may not be able to detect whether there is the security mark, so the second detector 132 can secondarily detect whether printing data includes a security mark. In this case, a general image matching scheme may be used. That is, the second detector 132 can compare the input printing data with security marks pre-stored in the storage unit 140 and can determine whether there is an image matching the security marks in the input data. Such a general image matching scheme is easily understood by those skilled in the related art, so a detailed description is omitted here.

In order to reduce the time taken to perform image matching, a security mark may be formed in only a predetermined area of printing data. For example, as illustrated in FIG. 2, a security mark 201 may be formed on only the bottom central portion of printing data. In this case, since the second detector 132 needs to detect the presence or absence of a security mark on only the bottom central portion of the printing data, the entire printing time can be reduced. Those skilled in the art will appreciate that the bottom central portion of the printing data is merely an example of the position of the predetermined area, and the predetermined area may alternatively be formed on any other fixed area of the printing data.

If the image matching scheme is used, extra time taken to perform the image matching may be required, so printing can be delayed. However, the time taken for the sensor 133 of the first detector 131 to measure a reflected wavelength or a change in a magnetic field is comparatively short. Thus, in accordance with example embodiments of the present general inventive concept, since the first detector 131 detects the presence or absence of a security mark on scanned paper prior to the second detector 132, if paper having the security mark printed using the supplementary developer is scanned and printed, the effect of reducing the printing time can be obtained.

The second detector 132 can detect the presence or absence of a security mark when the server 110b or the PC 110c inputs printing data. If the server 110b or the PC 110c inputs printing data, scanning may not be performed, so the first detector 131 may not be required to be used. Accordingly, without using the first detector 131, the second detector 132 can directly detect the presence or absence of the security mark. In this case, as described above, the image matching scheme may be applied.

In order to reduce the time taken to perform image matching, a security mark may be formed in only a predetermined area of printing data. For example, as illustrated in FIG. 2, a security mark 201 may be formed on only the bottom central portion of printing data. In this case, since the second detector 132 needs to detect the presence or absence of a security mark on only the bottom central portion of the printing data, the entire printing time can be reduced. As mentioned above, the bottom central portion of the printing data is merely an example of position of the predetermined area, and the predetermined area may alternatively be formed on any other fixed area of the printing data.

The storage unit 140 can store preset security marks, which may be terms indicating security such as “secret,” “secure document,” “confidential,” or “no copy,” or other terms or symbols. Predetermined security marks may be stored in the storage unit 140 as default values, or the user may add or delete security marks in the storage unit 140 if necessary. As described above, the second detector 132 can compare the security marks in the storage unit 140 with the input printing data using the image matching scheme to detect the present or absence of a security mark.

The result of detection of the detection unit 130 can be provided to the printing mode determination unit 150.

The printing mode determination unit 150 can determine a printing mode according to the result of detection of the detection unit 130. The printing mode may be a general printing mode or a secure printing mode.

The general printing mode may be set if the detection unit 130 does not detect a security mark. In the general printing mode, the result of detection of the detection unit 130 is provided to the control unit 170, and the control unit 170 can control the output unit 120 to print the input printing data without any restriction.

The secure printing mode can be set if the detection unit 130 detects a security mark. In the secure printing mode, when the output unit 120 prints the printing data, a predetermined limit may be given. That is, the secure printing mode may include a first mode to disallow printing, a second mode to display a warning, and a third mode to print limited number of copies fewer than or equal to a predetermined number of sheets of paper.

In the first mode, in order to disallow printing of the input printing data, the control unit 170 may give a printing disallowance command to the output unit 120 or ignore the printing data and not give any command to the output unit 120. Both manners can produce the same result, and there may be merely a fine difference in the control manner of the control unit 170.

In the second mode, a warning to inform the user that a secure document is being printed may be displayed. Such a warning may be displayed on a display apparatus of the input unit 110 or the display setting unit 180. After the warning is displayed, the printing data may be printed or may not be printed according to the user's selection. Alternatively, the printing data may not be printed collectively as in the first mode.

In the third mode, the number of printable sheets of input data may be limited. For example, if the user outputs more than the predetermined number of sheets of input data, the control unit 170 can provide a printing disallowance command to the output unit 120 so that more than the predetermined number of sheets cannot be printed.

The aforementioned first to third modes are merely examples, and any manners to limit printing of the printing data can be used as the secure printing mode. In accordance with example embodiments of the present general inventive concept, diverse types of the secure printing mode can be used, so printing of secure documents can be limited in a manner desired by the user.

The secure printing mode may be initialized as one of the first to third modes, or may be set by the user. Alternatively, a pop-up window may appear on the display apparatus of the input unit 110 or on the display setting unit 180 in order for the user to select the secure printing mode.

The developer mode determination unit 160 can determine a developer mode indicating whether to print a security mark detected by the detection unit 130 using the main developers or the supplementary developer. If the security mark should not be externally visible, the developer mode can be set to use the supplementary developer. Accordingly, the control unit 170 can control the output unit 120 to print the security mark using the supplementary developer. In order to clearly visibly inform the user that the printing data to be printed have a secure document, the developer mode can be set to use the main developers. Accordingly, the control unit 170 can control the output unit 120 to print the security mark using the externally visible main developers.

The developer mode may be initialized as the main developer or the supplementary developer, or may be set by the user. Alternatively, a pop-up window may appear on the display apparatus of the input unit 110 or on the display setting unit 180 in order for the user to select the developer mode.

The control unit 170 can control the output unit 120 to print the printing data differently according to the printing mode and the developer mode. In the general printing mode, the control unit 170 can control the output unit 120 to print the printing data as they are. In the first mode, the control unit 170 can control the output unit 120 not to print the printing data. In the second mode, the control unit 170 can display a warning message. In the third mode, the control unit 170 can control the output unit 120 to restrict the number of printed sheets of the printing data. If the developer mode is set to use the main developers, the control unit 170 can control the output unit 120 to print the security mark of the printing data using the main developers. If the developer mode is set to use the supplementary developer, the control unit 170 can control the output unit 120 to print the security mark of the printing data using the supplementary developer.

The display setting unit 180 can display and set the printing mode and the developer mode. As illustrated in FIG. 3, the display setting unit 180 may include a display window 181, and a manipulation pad 182. The display window 181 may display the printing mode, the developer mode, and the operating state. The user can change the printing mode and the developer mode using the manipulation pad 182.

The stopping unit 190 can stop the operation of the detection unit 130. When large quantities of general documents, not secure documents, are printed, a printing speed may decrease due to the time taken for the detection unit 130 to detect a security mark. In this case, the stopping unit 190 can stop the operation of the detection unit 130 to increase the printing speed. As illustrated in FIG. 3, if a button 191 on the display setting unit 180 is pressed, the stopping unit 190 can stop the operation of the detection unit 130.

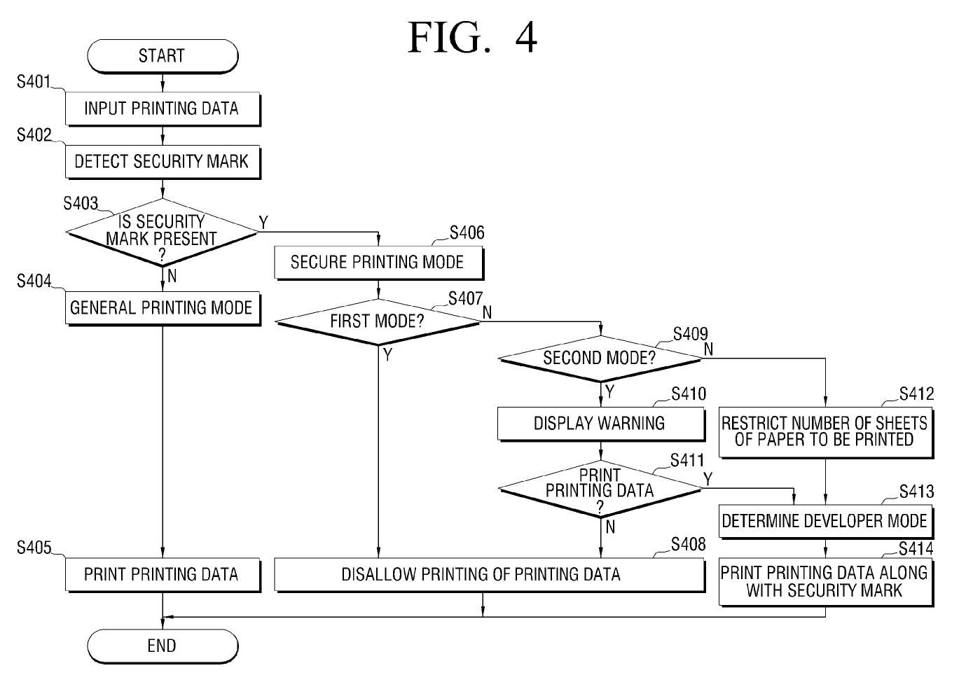

FIG. 4 is a flowchart illustrating a secure document printing method according to an exemplary embodiment of the present general inventive concept. Referring to FIG. 4, an example method of printing a secure document printing will be described.

In operation S401, printing data may be input.

In operation S402, a security mark can be detected from the input printing data.

In operation S403, whether a security mark is present in the printing data can be determined.

In operation S404, if there is no security mark in the printing data, the general printing mode can be executed, and in operation S405, the printing data can be printed without any restriction.

In operation S406, if a security mark is present in the printing data, the secure printing mode can be executed. The secure printing mode may include a first mode to disallow printing, a second mode to display a warning, and a third mode to print fewer than or equal to a predetermined number of sheets of paper. The secure printing mode may be an initial value, or may be set by the user.

In operation S407, whether the secure printing mode is set to the first mode can be determined.

In operation S408, if the secure printing mode is set to the first mode, printing of the printing data may be disallowed.

In operation S409, if the secure printing mode is not set to the first mode, whether the secure printing mode is set to the second mode can be determined.

In operation S410, if the secure printing mode is set to the second mode, a warning can be displayed. In operation S411, whether to print the printing data can be determined. If the printing data are determined to be printed, in operation S413, the developer mode can be determined. If the printing data are not determined to be printed, operation S408 can be performed.

In operation S412, if the secure printing mode is not set to the second mode, the secure printing mode can be set to the third mode and thus the number of sheets of paper to be printed is restricted.

In operation S413, the developer mode indicating whether to print the detected security mark using the main developers or the supplementary developer can be determined. The developer mode may be an initial value, or may be set by the user.

In operation S414, the printing data can be printed along with the security mark. The security mark may be printed using the main developers or the supplementary developer according to the developer mode determined in operation S413.

Although various example embodiments of the present general inventive concept have been illustrated and described, it will be appreciated by those skilled in the art that changes may be made in these example embodiments without departing from the principles and spirit of the general inventive concept, the scope of which is defined in the appended claims and their equivalents.

What is claimed is:

1. A printing system, comprising:
an output unit to print printing data using main developers including a cyan (C) developer, a yellow (Y) developer, a magenta (M) developer, a black (K) developer, and a supplementary developer;
a detection unit to detect whether a security mark is present in the printing data; and
a control unit to control the output unit to print the security mark using the supplementary developer if the detection unit detects the security mark in the printing data.

2. The printing system according to claim 1, wherein a color depth of the supplementary developer is lower than a color depth of the main developers.

3. The printing system according to claim 2, wherein the supplementary developer is one of a light C developer, a light Y developer, a light M developer, a light K developer, a white developer, and a transparent developer.

4. A printing system, comprising:
an input unit to input printing data;
an output unit to print the printing data using main developers including a cyan (C) developer, a yellow (Y) developer, a magenta (M) developer, a black (K) developer, and a supplementary developer;
a detection unit to detect whether a security mark is present in the printing data input by the input unit;
a printing mode determination unit to determine a printing mode according to the detection result of the detection unit;
a developer mode determination unit to determine a developer mode indicating whether to print the detected security mark using the main developers or the supplementary developer; and
a control unit to control the output unit to print the printing data and the security mark according to the printing mode and the developer mode.

5. The printing system according to claim 4, wherein the printing mode comprises:
a general printing mode to be set to print the printing data without restriction if the detection unit does not detect the security mark from the printing data; and
a secure printing mode to be set to print the printing data with restrictions if the detection unit detects the security mark from the printing data.

6. The printing system according to claim 5, wherein the secure printing mode comprises:
a first mode to disallow printing;
a second mode to display a warning; and
a third mode to allow printing of fewer than or equal to a predetermined number of sheets of paper.

7. The printing system according to claim 6, wherein the secure printing mode is initialized as one of the first to third modes.

8. The printing system according to claim 6, wherein the secure printing mode can be set by a user.

9. The printing system according to claim 4, wherein the developer mode is initialized as one of the main developers and the supplementary developer.

10. The printing system according to claim 4, wherein the developer mode can be set by a user.

11. The printing system according to claim 4, further comprising:
a storage unit to store a preset security mark,
wherein the detection unit detects whether the printing data include the security mark stored in the storage unit.

12. The printing system according to claim 11, wherein the user adds the security mark to the storage unit or deletes the security mark from the storage unit.

13. The printing system according to claim 4, wherein a color depth of the supplementary developer is lower than a color depth of the main developers.

14. The printing system according to claim 13, wherein the supplementary developer is one of a light C developer, a light Y developer, a light M developer, a light K developer, a white developer, and a transparent developer.

15. The printing system according to claim 13, wherein the detection unit comprises:
a first detector to detect whether the supplementary developer is present on the printing data by measuring a reflected wavelength; and
a second detector to detect whether the security mark is present in the printing data if the first detector does not detect the supplementary developer.

16. The printing system according to claim 15, wherein the first detector comprises:
a sensor to measure the reflected wavelength.

17. The printing system according to claim 4, wherein the supplementary developer comprises a magnetic or metal substance.

18. The printing system according to claim 17, wherein the detection unit comprises:
a first detector to detect whether the supplementary developer is present on the printing data by measuring a change in a magnetic field; and
a second detector to detect whether the security mark is present in the printing data if the first detector does not detect the supplementary developer.

19. The printing system according to claim 18, wherein the first detector comprises:
a sensor to measure the change in the magnetic field.

20. The printing system according to claim 4, further comprising:
a stopping unit to stop the operation of the detection unit.

21. The printing system according to claim 4, wherein the security mark is formed on a predetermined area of the printing data, and the detection unit detects whether the security mark is present on the predetermined area of the printing data.

22. The printing system according to claim 4, further comprising:
a display setting unit to display and set the printing mode and the developer mode.

23. A secure document printing method, comprising:
inputting printing data;
detecting whether a security mark is present in the printing data;
determining a printing mode according to the result of detection of the security mark;
determining a developer mode indicating whether to print the detected security mark using main developers or a supplementary developer; and
processing the printing data according to the printing mode and the developer mode.

24. A method of printing data, the method comprising:
detecting whether the data to be printed comprises a security mark;
determining whether the security mark is to be visibly printed on a document; and
printing the security mark on the document using main developers or a supplementary developer according to the result of the determining.

25. The method of claim 24, wherein the detecting whether the data comprises a security mark comprises scanning the data to detect whether supplemental developer is present on the scanned data.

26. The method of claim 25, further comprising:
measuring a characteristic of the detected supplemental developer.

27. The method of claim 26, wherein the characteristic is one of a reflected wavelength and a magnetic field of the detected supplemental developer.

28. The method of claim 24, further comprising:
adding a substance to the supplemental developer to change a reflected wavelength of the supplemental developer.

29. An image forming apparatus, comprising:
an input unit to input image data;
a detection unit to detect whether a security mark is present in the image data; and
an output unit to print the security mark using a supplementary developer when the detection unit detects the security mark in the image data.

30. The image forming apparatus of claim 29, wherein the detection unit comprises:
a first detector to detect whether the security mark is present when the image data is input by a scanner; and
a second detector to detect whether the security mark is present when the image data is input by a server or personal computer (PC).

31. The image forming apparatus of claim 30, wherein the first detector detects whether the security mark is present by detecting whether supplemental developer is present in the scanned image data, and the second detector detects whether the security mark is present by using an image matching scheme.

32. The image forming apparatus of claim 29, wherein the security mark is located in a predetermined area of the image data.
